(19) United States
(12) Patent Application Publication
(10) Pub. No.: US 2026/0010086 A1
(43) Pub. Date: Jan. 8, 2026

(54) IMAGE FORMING APPARATUS

(71) Applicant: FUJIFILM Business Innovation Corp., Tokyo (JP)

(72) Inventor: Yuji KANDO, Kanagawa (JP)

(73) Assignee: FUJIFILM Business Innovation Corp., Tokyo (JP)

(21) Appl. No.: 19/050,609

(22) Filed: Feb. 11, 2025

(30) Foreign Application Priority Data
Jul. 8, 2024 (JP) 2024-109876

(51) Int. Cl. G03G 15/01

(52) U.S. Cl. CPC G03G 15/011; G03G 2215/0154

(57) ABSTRACT

An image forming apparatus includes: a rotatable photoconductor; an exposure device that forms a latent image by radiating light from a light emitting element disposed along an axial direction of the photoconductor, an interval maintaining member that maintains an interval between the photoconductor and the exposure device; and a support member to which at least the photoconductor and the exposure device are attached, in which an anti-vibration member is interposed between the interval maintaining member and a contact portion of the exposure device.

### CROSS-REFERENCE TO RELATED APPLICATIONS

This application is based on and claims priority under 35 USC 119 from Japanese Patent Application No. 2024-109876 filed Jul. 8, 2024.

### BACKGROUND

### (i) Technical Field

The present disclosure relates to an image forming apparatus.

### (ii) Related Art

Japanese Patent No. 5205830 (claim 1 and FIGS. 1 to 5) discloses an image forming apparatus including a photoconductor drum, a light emitter, a first biasing unit, and a second biasing unit.

The light emitter includes a plurality of light emitting elements arranged along the axial direction of the photoconductor drum to emit light toward the surface of the photoconductor drum, and both end portions of the light emitter are removably supported by a frame member. The first biasing unit biases a first inner surface portion that is an inner surface that constitutes a hollow portion formed in the light emitter. The second biasing unit biases a second inner surface portion that is a different inner surface that faces the first inner surface portion.

Japanese Patent No. 7163597 (claim 1 and FIGS. 1 to 9) discloses an image forming apparatus including a rotatable image holding body and an exposure device that exposes the image holding body to light.

Japanese Patent No. 7163597 indicates that the exposure device includes an exposure unit, a weight, and an elastic portion.

The exposure unit includes a plurality of exposure elements arranged along the axial direction of the image holding body, is positioned with respect to the image holding body at both ends in the axial direction, and exposes the image holding body to light by outputting light to the image holding body. The weight is disposed to face the exposure unit, has a mass determined in advance, and has an opening that extends in the axial direction. The elastic portion is elastic, is disposed between the exposure unit and the weight, and supports the weight in a vibratable manner.

Japanese Patent No. 7163597 also indicates that the elastic portion is provided continuously from one end side to the other end side of the weight in the axial direction by penetrating the opening of the weight in the axial direction.

Japanese Unexamined Patent Application Publication No. 2012-254539 (claim 1 and FIGS. 1 and 16) discloses an image forming apparatus including an image carrier and a printer head that emits a luminous flux to the image carrier.

Japanese Unexamined Patent Application Publication No. 2012-254539 indicates that the printer head includes a light source, an optical system, a housing, and one overhead member.

The light source includes a plurality of light emitting portions arranged along a first direction. The optical system condenses a plurality of luminous fluxes output from the light source in a second direction that is orthogonal to the first direction. The housing includes a top plate that holds the optical system, and two side plates that face each other while sandwiching the light source in a third direction that is orthogonal to each of the first direction and the second direction, the side plates being fixed to the top plate in the vicinity of respective end portions of the side plates on one side in the second direction. The overhead member extends between respective parts of end portions of the side plates on the other side in the second direction.

### SUMMARY

Aspects of non-limiting embodiments of the present disclosure relate to providing an image forming apparatus capable of easily suppressing transmission of unwanted vibration to an exposure device from the outside, compared to the case where an anti-vibration member is not interposed or a non-contact structure is not adopted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a rotatable photoconductor; an exposure device that forms a latent image by radiating light from a light emitting element disposed along an axial direction of the photoconductor; an interval maintaining member that maintains an interval between the photoconductor and the exposure device; and a support member to which at least the photoconductor and the exposure device are attached, in which an anti-vibration member is interposed between the interval maintaining member and a contact portion of the exposure device.

### BRIEF DESCRIPTION OF THE DRAWINGS

Exemplary embodiments of the present disclosure will be described in detail based on the following figures, wherein:

FIG. 1 illustrates an overview of an image forming apparatus according to a first exemplary embodiment;

FIG. 2 illustrates an overview of an imaging unit of the image forming apparatus in FIG. 1;

FIG. 3 illustrates an overview of components to suppress propagation of vibration to an exposure device of the image forming apparatus in FIG. 1;

FIG. 4 illustrates an overview of components to suppress propagation of vibration to an exposure device of an image forming apparatus according to a second exemplary embodiment;

FIG. 5 illustrates an overview of components to suppress propagation of vibration to an exposure device of an image forming apparatus according to a third exemplary embodiment;

FIG. 6 illustrates an overview of components to suppress propagation of vibration to an exposure device of an image forming apparatus according to a fourth exemplary embodiment;

FIG. 7 illustrates an overview of components to suppress propagation of vibration to an exposure device of an image forming apparatus according to a fifth exemplary embodiment;

FIG. 8 is a graph illustrating an example of settings to adjust meshing frequencies; and

FIG. 9 illustrates an overview of components according to a comparative example and an example of vibration propagation in such a case.

### DETAILED DESCRIPTION

Exemplary embodiments of the present disclosure will be described below.

### First Exemplary Embodiment

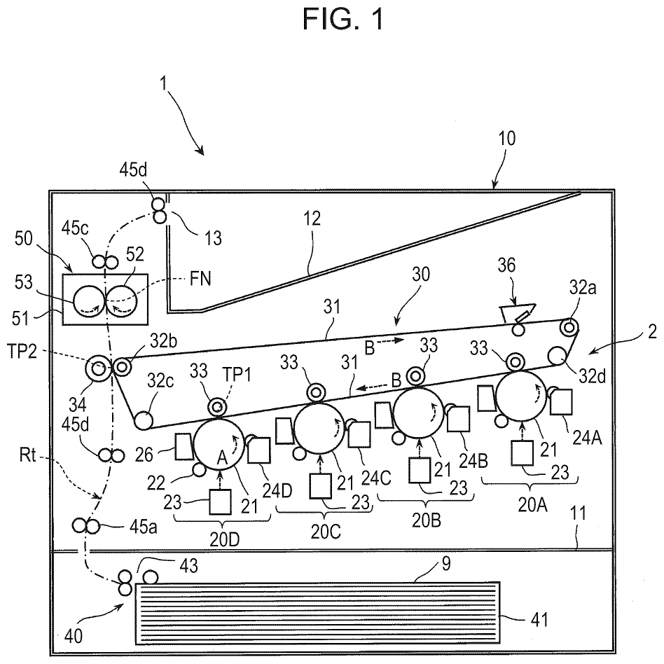

FIG. 1 illustrates an overview of an image forming apparatus according to a first exemplary embodiment of the present disclosure.

Herein and in the drawings, substantially the same constituent elements are given the same reference numerals. Herein, redundant description of the same constituent elements is omitted.

In FIG. 1, etc., the arrow +X indicates the right direction when the image forming apparatus 1, etc., is seen from the front surface side, and the arrow-X indicates the left direction when the image forming apparatus 1, etc., is seen from the same side. In FIG. 1, etc., the arrow +Y indicates the upper direction of the image forming apparatus 1, etc., and the arrow-Y indicates the lower direction of the image forming apparatus 1, etc. In FIG. 1, etc., the symbol +Z indicates the farther side in the depth direction when the image forming apparatus 1, etc., is seen from the front surface side, and the arrow-Z indicates the closer side in the depth direction when the image forming apparatus 1, etc., is seen from the same side.

In FIG. 1, etc., the symbol “X” surrounded by a circle indicates the direction from the closer side toward the farther side of the drawing sheet surface. In FIG. 1, etc., the symbol of a dot surrounded by a circle indicates the direction from the farther side toward the closer side of the drawing sheet surface.

### (Image Forming Apparatus)

An image forming apparatus 1 according to the first exemplary embodiment includes an image forming unit 2, a medium supply unit 40, a fixing unit 50, etc., disposed inside a housing 10.

The housing 10 is a structure formed in a predetermined shape having an internal space.

The housing 10 is divided into an upper portion and a lower portion by a partition plate 11, for example. The image forming unit 2, the fixing unit 50, etc., are disposed in the upper portion. An ejection storage portion 12 is formed at an upper surface portion of the upper portion, and an ejection port 13 is formed in a wall surface portion of the ejection storage portion 12. The medium supply unit 40, etc., are disposed in the lower portion.

The image forming unit 2 forms a toner image as an unfixed image on a recording medium 9.

The image forming unit 2 includes an imaging portion 20, an intermediate transfer unit 30, and the medium supply unit 40.

The imaging portion 20 forms a toner image by developing a latent image corresponding to image information using a developer.

As illustrated in FIG. 1, the imaging portion 20 according to the first exemplary embodiment is composed of four imaging units 20A, 20B, 20C, and 20D.

The imaging units 20A, 20B, 20C, and 20D are each a unit that prepares a toner image through an electrophotographic system. The imaging units 20A, 20B, 20C, and 20D each include a photoconductor drum 21 as an example of a rotatable photoconductor. The imaging units 20A, 20B, 20C, and 20D each prepare an unfixed image developed on the photoconductor drum 21 using a developer for a predetermined color (A, B, C, D).

Examples of the predetermined color (A, B, C, D) include colors such as yellow, magenta, cyan, and black. The photoconductor drum 21 is a photoconductor in the form of a drum.

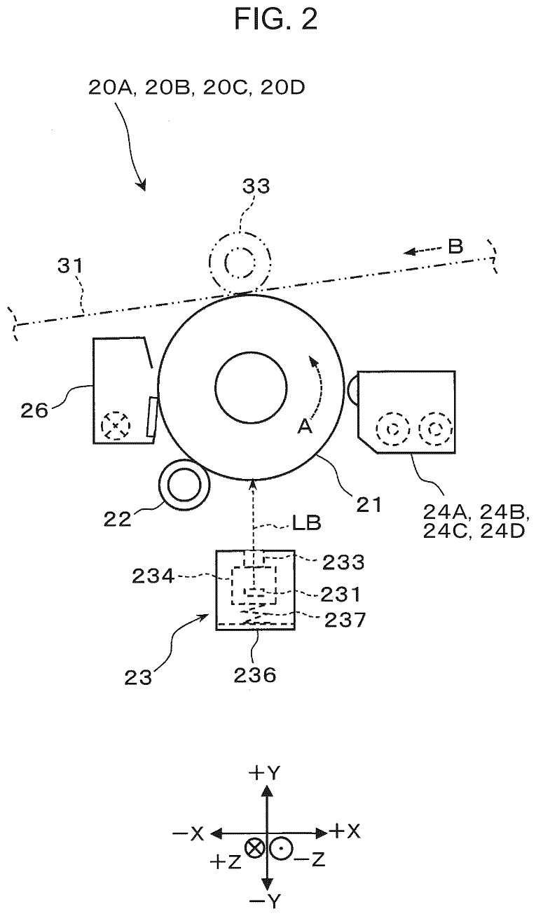

As illustrated in FIGS. 1 and 2, the imaging units 20A, 20B, 20C, and 20D each include a charging device 22, an exposure device 23, a developing device 24, a drum cleaning device 26, etc., disposed around the photoconductor drum 21.

In FIG. 1, reference numerals of the charging device 22, the exposure device 23, and the drum cleaning device 26 are indicated only for the imaging unit 20D as a representative. The developing devices 24 use developers for different colors (A, B, C, D), and therefore are indicated as developing devices 24A, 24B, 24C, and 24D.

The photoconductor drum 21 rotates in a direction indicated by the arrow A when power is transmitted from a rotary drive device (not illustrated).

The exposure device 23 forms an electrostatic latent image by radiating light LB to the outer peripheral surface of the photoconductor drum 21 that has been charged. The exposure device 23 receives image information input from an external connection device (not illustrated) such as an information terminal device and a storage medium connected to the image forming apparatus 1.

The developing devices 24A, 24B, 24C, and 24D each include a developing housing, a developing roller, a transport member, a layer thickness regulation member, etc. Among these, the developing roller, the transport member, etc., rotate in a predetermined direction when power is transmitted from a rotary drive device (not illustrated).

The intermediate transfer unit 30 relays and transfers toner images prepared by the imaging units 20A, 20B, 20C, and 20D of the imaging portion 20 to the recording medium 9.

The intermediate transfer unit 30 according to the first exemplary embodiment includes an intermediate transfer belt 31, a first transfer device 33, a second transfer device 34, a belt cleaning device 36, etc.

The intermediate transfer belt 31 is an endless belt capable of holding toner images on the belt outer peripheral surface principally using an electrostatic force and transferring the toner images.

The intermediate transfer belt 31 rotates while passing through the photoconductor drums 21 of the imaging units 20A, 20B, 20C, and 20D. Specifically, the intermediate transfer belt 31 is wound around a predetermined number of support rollers 32a, 32b, 32c, and 32d, and rotates in a direction indicated by the arrow B. Among these, the support roller 32a is a driving roller, and the support roller 32b is a second transfer back surface roller. The support roller 32a as a driving roller receives power transmitted from a rotary drive device (not illustrated).

The first transfer device 33 performs a first transfer in which the toner images formed on the photoconductor drums 21 are transferred to the outer peripheral surface of the intermediate transfer belt 31. In the intermediate transfer unit 30, the position at which the first transfer device 33 faces the photoconductor drum 21 while sandwiching the intermediate transfer belt 31 is defined as a first transfer position TP1.

The first transfer device 33 may be a device that uses a first transfer roller that rotates in contact with the outer peripheral surface of the intermediate transfer belt 31 at the first transfer position TP1. A predetermined first transfer bias is supplied to the first transfer roller from a power supply device (not illustrated).

The second transfer device 34 performs a second transfer in which the toner images that have been transferred to the outer peripheral surface of the intermediate transfer belt 31 through the first transfer are transferred to one surface of the recording medium 9. In the intermediate transfer unit 30, the position at which the second transfer device 34 faces the support roller 32b while sandwiching the intermediate transfer belt 31 is defined as a second transfer position TP2.

The second transfer device 34 may be a second transfer roller that rotates in contact with the outer peripheral surface of the intermediate transfer belt 31 at the second transfer position TP2. A predetermined second transfer bias is supplied to the second transfer roller from a power supply device (not illustrated).

The medium supply unit 40 stores the recording medium 9 on which an image is to be formed, and supplies the recording medium 9 to a predetermined position of the image forming unit 2.

In the first exemplary embodiment, the predetermined position is the second transfer position TP2 of the intermediate transfer unit 30.

The medium supply unit 40 includes a storage body 41 that stores a plurality of recording media 9, a feeding device 43 that feeds the recording media 9, one at a time, from the storage body 41, etc. The storage body 41 includes a loading plate on which the recording media 9 are to be loaded.

The recording media 9 may be transported to the image forming unit 2, and hold a toner image transferred thereto. The recording media 9 may be media such as paper cut to a predetermined size.

A plurality of sets of the storage body 41 and the feeding device 43 may be provided.

A medium transport path Rt indicated by the dot-and-dash line in FIG. 1 is disposed in the housing 10.

The medium transport path Rt includes at least a transport path that leads from the medium supply unit 40 to the ejection port 13 by way of the second transfer position TP2 and the fixing unit 50. The medium transport path Rt is composed of a predetermined number of transport roller pairs 45a, 45b, 45c, and 45d, a transport guide member (not illustrated), etc.

The fixing unit 50 fixes the toner images formed on the recording medium 9 in the image forming unit 2 to the recording medium 9.

The fixing unit 50 is constituted by disposing a heating rotary body 52, a pressurizing rotary body 53, etc., inside a fixing housing 51. The heating rotary body 52 and the pressurizing rotary body 53 are rotary bodies formed in the form of a roller or a belt. The heating rotary body 52 and the pressurizing rotary body 53 rotate in directions indicated by the broken arrows in contact with each other under pressurization.

In the fixing unit 50, a contact portion between the heating rotary body 52 and the pressurizing rotary body 53 serves as a fixing nip FN through which the recording medium 9 passes to be subjected to a fixing process. In the fixing unit 50, one of the heating rotary body 52 and the pressurizing rotary body 53 rotates when power is transmitted from a rotary drive device (not illustrated).

### (Image Forming Operation)

The image formation by the image forming apparatus 1 is performed as follows.

Here, it is assumed that toner images are formed by all the imaging units 20A, 20B, 20C, and 20D of the image forming unit 2.

First, when the imaging unit 20A, 20B, 20C, 20D of the imaging portion 20 receives an instruction for image forming operation, the photoconductor drum 21 starts to rotate in a direction indicated by the arrow A.

In the intermediate transfer unit 30, at the time of image forming operation, the intermediate transfer belt 31 starts to rotate in a direction indicated by the arrow B.

Subsequently, in the imaging unit 20A, 20B, 20C, 20D, the charging device 22 charges the outer peripheral surface of the photoconductor drum 21 to a predetermined surface potential.

After that, the exposure device 23 exposes the outer peripheral surface of the photoconductor drum 21 that has been charged to light for an image for each color component constituted in correspondence with image information. Consequently, an electrostatic latent image for the predetermined color component (A, B, C, D) is separately formed on the outer peripheral surface of the photoconductor drum 21.

Subsequently, the developing device 24A, 24B, 24C, 24D develops the electrostatic latent image on the outer peripheral surface of the photoconductor drum 21 using a developer for the corresponding color. Consequently, a toner image in the predetermined color (A, B, C, D) is separately formed on the outer peripheral surface of the photoconductor drum 21.

Subsequently, in the imaging unit 20A, 20B, 20C, 20D of the imaging portion 20, the toner image on the photoconductor drum 21 is transferred to the intermediate transfer unit 30.

In the imaging unit 20A, 20B, 20C, 20D, the drum cleaning device 26 cleans the outer peripheral surface of the photoconductor drum 21 after the transfer.

When the photoconductor drum 21 is cleaned, the imaging unit 20A, 20B, 20C, 20D makes preparations for the next imaging.

In the intermediate transfer unit 30, on the other hand, the first transfer device 33 performs a first transfer in which the toner images on the photoconductor drums 21 are sequentially transferred to the outer peripheral surface of the intermediate transfer belt 31 passing through the first transfer position TP1.

At this time, the intermediate transfer belt 31 transports the toner images that have been transported to the outer peripheral surface thereof through the first transfer to the second transfer position TP2.

In the medium supply unit 40, the feeding device 43 feeds the predetermined recording medium 9 from the storage body 41 toward the second transfer position TP2 of the intermediate transfer unit 30 in accordance with the second transfer timing. At this time, the recording medium 9 is transported to the second transfer position TP2 by way of the medium transport path Rt.

Subsequently, in the intermediate transfer unit 30, the second transfer device 34 performs a second transfer in which the toner image is transferred from the outer peripheral surface of the intermediate transfer unit 30 passing through the second transfer position TP2 to the recording medium 9.

In the intermediate transfer unit 30, the belt cleaning device 36 cleans the outer peripheral surface of the intermediate transfer belt 31 after the second transfer.

When the intermediate transfer belt 31 is cleaned, the intermediate transfer unit 30 makes preparations for the next transfer.

The recording medium 9 to which the toner image has been transferred in the intermediate transfer unit 30 through the second transfer is transported to be introduced into the fixing unit 50 by way of the medium transport path Rt.

In the fixing unit 50, the recording medium 9 to which the toner image has been transferred is heated under pressurization when passing through the fixing nip FN. Consequently, the toner image is fused and fixed to the recording medium 9.

Finally, the recording medium 9 after the fixation is transported to be ejected from the ejection port 13 by way of the medium transport path Rt, and thereafter stored in the ejection storage portion 12.

Through the processes described above, the image forming operation for one surface of a single recording medium 9 is finished.

### (Configuration of Exposure Device, Photoconductor Drum, etc.)

Next, the configuration of the exposure device 23, the photoconductor drum 21, etc., of the imaging unit 20A, 20B, 20C, 20D will be described.

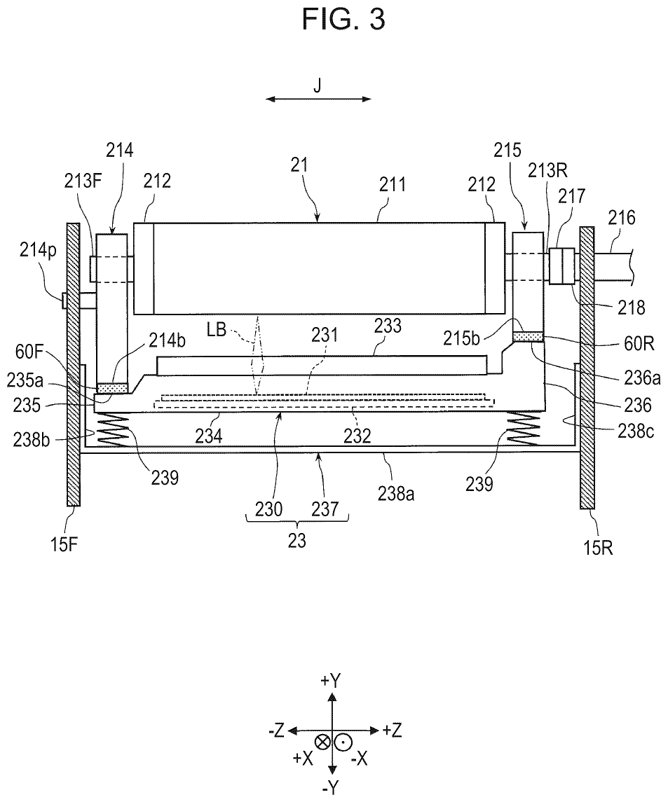

As illustrated in FIG. 3, the exposure device 23 according to the first exemplary embodiment is constituted of a light emitting portion 230 and a holding portion 237.

The light emitting portion 230 radiates light that forms an electrostatic latent image. The holding portion 237 holds the light emitting portion 230.

As illustrated in FIGS. 2 and 3, the light emitting portion 230 includes light emitting elements 231, a circuit substrate 232, an imaging lens 233, a support member 234, etc.

The light emitting elements 231 are elements (light sources) disposed along an axial direction J of the photoconductor drum 21 to emit light. The light emitting elements 231 may be a large number of light emitting diodes (LEDs). The light emitting elements 231 are constituted as an LED array in which an LED chip in which a large number of LEDs are arranged linearly along the axial direction J is disposed.

The circuit substrate 232 is a substrate on which a circuit that supplies various signals to control drive of the LED array is mounted.

The imaging lens 233 is a lens that forms an image on the surface of the photoconductor drum 21 using the light LB output from the LEDs of the LED array. The imaging lens 233 may be a lens array in which a large number of rod lenses are disposed along the axial direction J of the photoconductor drum 21.

The support member 234 supports the light emitting elements 231, the circuit substrate 232, and the imaging lens 233. The light emitting elements 231 and the circuit substrate 232 are disposed inside the support member 234. The imaging lens 233 is disposed on an upper surface portion of the support member 234 that faces the photoconductor drum 21.

The support member 234 is a structure shaped to extend along the axial direction J of the photoconductor drum 21, and is formed from a resin material, etc.

Further, the support member 234 includes positioning portions 235 and 236 provided at both end portions in the axial direction J.

The positioning portions 235 and 236 include upper end portions 235a and 236a set at predetermined heights in the support member 234. The positioning portions 235 and 236 are configured such that the upper end portions 235a and 236a may contact lower end portions 214b and 215b of interval maintaining members 214 and 215 to be discussed later.

The exposure device 23 constituted of the light emitting elements 231 composed of the LEDs is occasionally referred to as an “LED print head”, or an “LPH” for short.

As illustrated in FIG. 3, the holding portion 237 includes a holding frame 238, clastic members 239, etc.

The holding frame 238 holds the light emitting portion 230. The holding frame 238 includes a body portion 238a and side wall portions 238b and 238c.

The body portion 238a is a plate-shaped portion having a predetermined width and extending along the axial direction J of the photoconductor drum 21. The side wall portions 238b and 238c are provided at both end portions of the body portion 238a in the longitudinal direction, and bent substantially perpendicularly to extend upward to serve as side walls.

The holding frame 238 is fixed to frames 15F and 15R as examples of a support member to which at least the photoconductor drum 21 and the exposure device 23 are attached. The holding frame 238 is fixed by a fixing unit such as screwing and welding with the side wall portions 238b and 238c in contact with the frames 15F and 15R.

The elastic members 239 attach the light emitting portion 230 to the holding frame 238 in an elastically biased state.

The elastic members 239 function to suppress transmission of unwanted vibration from the holding frame 238 to the light emitting portion 230. The elastic members 239 also function to elastically press the positioning portions 235 and 236 of the support member 234 of the light emitting portion 230 against the interval maintaining members 214 and 215.

Two clastic members 239 are disposed between the respective lower ends of the positioning portions 235 and 236 of the support member 234 of the light emitting portion 230 and the upper surface of the body portion 238a of the holding frame 238.

Examples of the elastic members 239 include coil springs. The elastic members 239 may be any member capable of exhibiting the functions described above, and other clastic members such as plate springs may also be used.

The respective lower end portions of the two elastic members 239 composed of coil springs are fixed to the upper surface of the body portion 238a of the holding frame 238. The respective upper ends of the two elastic members 239 are fixed to the respective lower ends of the positioning portions 235 and 236 of the support member 234.

The respective upper ends of the two elastic members 239 may not be fixed to the respective lower ends of the positioning portions 235 and 236 of the support member 234 in the following case. The case includes a case with a support structure with which the light emitting portion 230 is guided so as to be movable in the up-down direction, for example.

As illustrated in FIG. 3, the photoconductor drum 21 includes a body portion 211, flange end portions 212, shaft portions 213F and 213R, etc.

The body portion 211 is a portion formed in a cylindrical shape or a circular column shape and provided with a photosensitive function layer in which an electrostatic latent image is to be formed, etc.

The flange end portions 212 are rigid portions provided at both end portions of the body portion 211 in the axial direction J.

The shaft portions 213F and 213R project outward from the central position of the flange end portions 212 for a predetermined length. The shaft portion 213F is disposed on the front surface side (front side) of the image forming apparatus 1. The shaft portion 213R is disposed on the back surface side (rear side) of the image forming apparatus 1.

The shaft portions 213F and 213R serve as rotary shafts that support rotation of the photoconductor drum 21.

In the photoconductor drum 21, as illustrated in FIG. 3, the shaft portions 213F and 213R are provided with interval maintaining members 214 and 215.

The interval maintaining members 214 and 215 maintain the interval between the photoconductor drum 21 and the light emitting portion 230 of the exposure device 23 within a predetermined range. To be exact, the interval maintaining members 214 and 215 function to suppress the above interval to be less (smaller) than a predetermined value.

The interval maintaining members 214 and 215 each include a bearing portion for the shaft portion 213F, 213R and a support portion that supports the bearing portion.

The support portions of the interval maintaining members 214 and 215 are shaped such that the lower end portions 214b and 215b of the support portions face the upper end portions 235a and 236a of the positioning portions 235 and 236.

Further, one of the interval maintaining members, 214, includes a positioning protrusion 214p that projects outward (actually toward the front surface side). The positioning protrusion 214p is fitted into a positioning hole (not illustrated) provided in the frame 15F.

The interval maintaining member 214 is fixed at a predetermined attachment position by fitting the positioning protrusion 214p into the positioning hole of the frame 15F.

Further, the shaft portion 213R of the photoconductor drum 21 is coupled to a power transmission shaft 216 that rotates when power is transmitted from a rotary drive device (not illustrated).

The shaft portion 213R and the power transmission shaft 216 are coupled to each other via a pair of releasable shaft joints (couplings) 217 and 218. The shaft joint 217 is fixed to the shaft portion 213R. The shaft joint 218 is fixed to the power transmission shaft 216.

The power transmission shaft 216 is supported on the frame 15R via a bearing (not illustrated).

The photoconductor drum 21 rotates in a direction indicated by the arrow A when power is transmitted from the power transmission shaft 216 via the shaft portion 213R.

The frames 15F and 15R are frames to which at least the photoconductor drum 21 and the exposure device 23 are attached.

The frame 15F is disposed on the front surface side of the image forming apparatus 1.

The frame 15R is disposed on the back surface side of the image forming apparatus 1. The frame 15R also constitutes a part of the housing 10.

### (Malfunction Caused by Propagation of Vibration to Exposure Device)

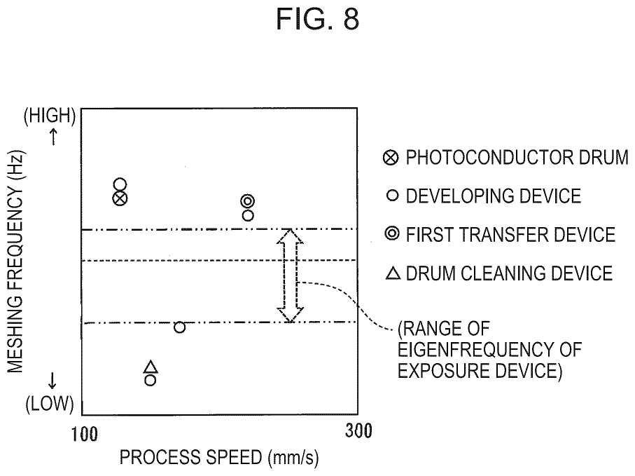

The image forming apparatus 1 is set (designed) such that the meshing frequencies of devices disposed around the exposure device 23 to perform operation such as rotation are adjusted in advance, as indicated in FIG. 8.

That is, the meshing frequencies of gears that transmit power to the devices that perform operation such as rotation are individually set to values outside the range of the eigenfrequency of the exposure device 23 not to generate resonance. The devices disposed around the exposure device 23 to perform operation such as rotation include the photoconductor drum 21, the developing device 24, the first transfer device 33, the drum cleaning device 26, etc.

Consequently, the exposure device 23 does not easily resonate even if vibration generated during operation such as rotation of devices disposed around the exposure device 23 is propagated.

Just for reference, in the setting example indicated in FIG. 8, the meshing frequency of the photoconductor drum 21 is set to a value slightly off the upper limit value of the eigenfrequency of the exposure device 23.

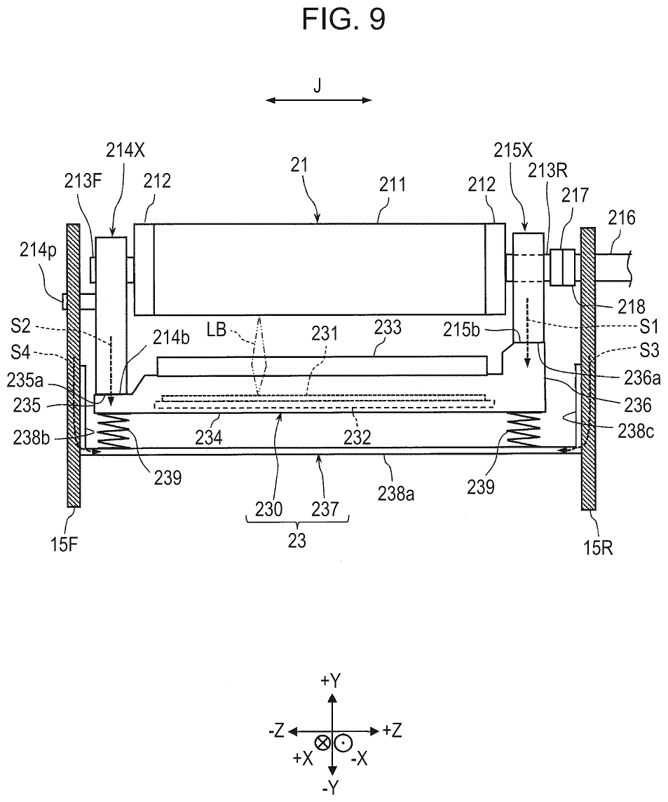

In practice, however, the following malfunction may occur in the image forming apparatus 1 that adopts the configuration illustrated in FIG. 9.

In the configuration illustrated in FIG. 9, the lower end portions 214b and 215b of interval maintaining members 214X and 215X are in contact with the upper end portions 235a and 236a of the positioning portions 235 and 236 of the exposure device 23.

In the image forming apparatus 1 that adopts this configuration, a poor image quality (banding) due to propagation of vibration generated by rotation of the photoconductor drum 21 to the exposure device 23 may be caused. Examples of the banding include streaked or striped image non-uniformities.

The factors for such a poor image quality are considered to include resonance of the exposure device 23 generated when parts S1 and S2 (see FIG. 9) of vibration generated by rotation of the photoconductor drum 21 is directly transmitted to the exposure device 23 by way of the interval maintaining members 214X and 215X.

### (Components to Suppress Propagation of Vibration to Exposure Device)

In order to address the above issue, in the image forming apparatus 1 according to the first exemplary embodiment, as illustrated in FIG. 3, anti-vibration members 60F and 60R are interposed between the interval maintaining members 214 and 215 and contact portions of the exposure device 23.

In the first exemplary embodiment, the anti-vibration members 60F and 60R are interposed between the lower end portions 214b and 215b of the interval maintaining members 214 and 215 and the upper end portions 235a and 236a of the positioning portions 235 and 236 of the support member 234 of the exposure device 23.

The anti-vibration members 60F and 60R are capable of suppressing transmission of vibration.

Examples of the anti-vibration members 60F and 60R include a member made of a material such as rubber capable of reducing or eliminating propagation of vibration.

The anti-vibration members 60F and 60R have a predetermined thickness enough to obtain an anti-vibration effect. The predetermined thickness may be set to a value of 1 mm or more, for example. When the thickness is less than 1 mm, propagation of vibration may not be sufficiently reduced or eliminated.

The height of at least one of the lower end portions 214b and 215b of the interval maintaining members 214 and 215 and the upper end portions 235a and 236a of the positioning portions 235 and 236 is adjusted in consideration of the interposition of the anti-vibration members 60F and 60R.

Further, the anti-vibration members 60F and 60R are pasted to the upper end portions 235a and 236a of the positioning portions 235 and 236. The anti-vibration members 60F and 60R may be pasted to the lower end portions 214b and 215b of the interval maintaining members 214 and 215.

In the image forming apparatus 1 according to the first exemplary embodiment, the photoconductor drum 21 may generate vibration by rotating during image forming operation. Parts S1 and S2 (see FIG. 9) of the generated vibration are occasionally transmitted to the interval maintaining members 214 and 215.

In the image forming apparatus 1, however, the parts S1 and S2 of the vibration are reduced or eliminated by the anti-vibration members 60F and 60R.

In the image forming apparatus 1, parts S3 and S4 of the vibration generated by rotational operation of the photoconductor drum 21, etc., are occasionally propagated to the exposure device 23 via the frames 15F and 15R. Also in this case, the parts S3 and S4 of the vibration are absorbed by the clastic members 239 of the holding portion 237 of the exposure device 23 and not easily propagated, if the parts S3 and S4 of the vibration are small and within an expected range.

### Second Exemplary Embodiment

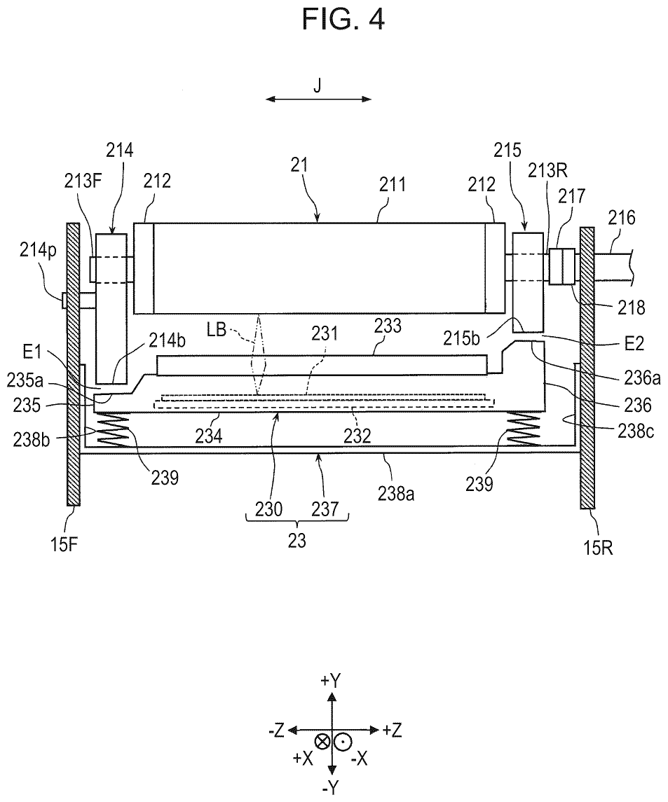

FIG. 4 illustrates an overview of components to suppress propagation of vibration to the exposure device 23 of an image forming apparatus according to a second exemplary embodiment.

The image forming apparatus 1 according to the second exemplary embodiment has the same configuration as the image forming apparatus 1 according to the first exemplary embodiment except that components to suppress propagation of vibration are changed.

In the second exemplary embodiment, as illustrated in FIG. 4, the interval maintaining members 214 and 215 and contact portions of the exposure device 23 are spaced from each other.

To be specific, the lower end portions 214b and 215b of the interval maintaining members 214 and 215 and the upper end portions 235a and 236a of the positioning portions 235 and 236 of the support member 234 of the exposure device 23 are spaced from each other.

The interval maintaining member 214 and the exposure device 23 are spaced from each other with a predetermined gap E1. The interval maintaining member 215 and the exposure device 23 are spaced from each other with a predetermined gap E2. That is, the interval maintaining members 214 and 215 and the exposure device 23 are structured to make no contact with each other.

The gaps E1 and E2 are normally set to the same value. The gaps E1 and E2 are set to a value within the range of 0.95 mm to 1.05 mm, for example. When the gaps are less than the above lower limit value, a malfunction such as the deviation of a focal point during exposure by the exposure device 23 may occur. When the gaps are more than the above upper limit value, on the contrary, a similar malfunction may also occur.

The clastic members 239 of the holding portion 237 of the exposure device 23 elastically bias the upper end portions 235a and 236a of the positioning portions 235 and 236 of the support member 234 upward.

However, the elastic members 239 are set to a condition to keep the upper end portions 235a and 236a of the positioning portions 235 and 236 in no contact with the lower end portions 214b and 215b of the interval maintaining members 214 and 215.

Also in the image forming apparatus 1 according to the second exemplary embodiment, the photoconductor drum 21 may generate vibration by rotating during image forming operation, and parts S1 and S2 (see FIG. 9) of the vibration may be transmitted to the interval maintaining members 214 and 215.

In the image forming apparatus 1, however, the parts S1 and S2 of the vibration are blocked by the presence of the gaps E1 and E2 due to the spacing, and are not transmitted to the upper end portions 235a and 236a of the positioning portions 235 and 236 of the exposure device 23.

### Third Exemplary Embodiment

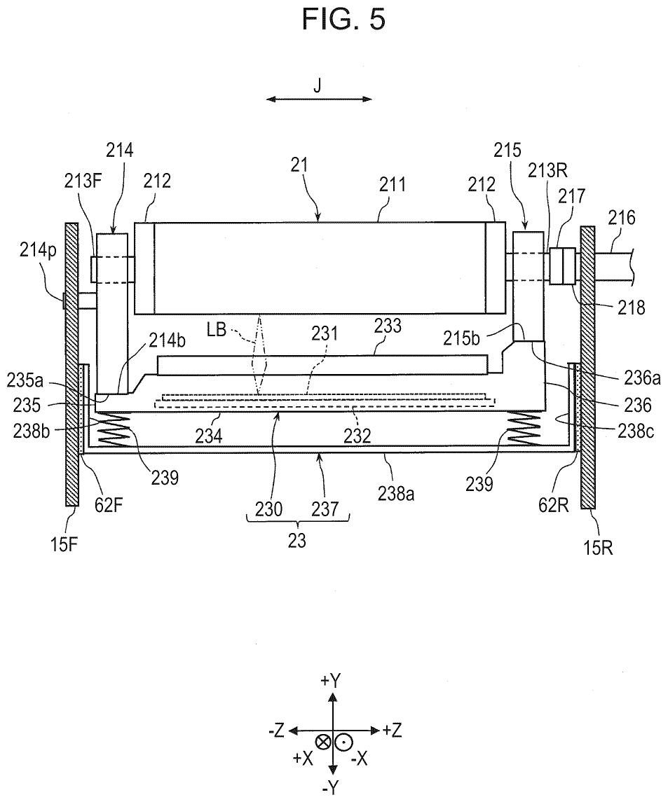

FIG. 5 illustrates an overview of components to suppress propagation of vibration to the exposure device 23 of an image forming apparatus according to a third exemplary embodiment.

The image forming apparatus 1 according to the third exemplary embodiment has the same configuration as the image forming apparatus 1 according to the first exemplary embodiment except that components to suppress propagation of vibration are changed.

In the third exemplary embodiment, as illustrated in FIG. 5, anti-vibration members 62F and 62R are interposed between the exposure device 23 and contact portions of the frames 15F and 15R.

To be specific, the anti-vibration members 62F and 62R are interposed between the side wall portions 238b and 238c of the holding frame 238 of the holding portion 237 of the exposure device 23 and contact portions of the frames 15F and 15R.

The anti-vibration members 62F and 62R may be substantially the same as the anti-vibration members 60F and 60R according to the first exemplary embodiment.

The anti-vibration members 62F and 62R are pasted to the side wall portions 238b and 238c of the holding frame 238. The anti-vibration members 62F and 62R may be pasted to the side of the frames 15F and 15R.

In the image forming apparatus 3 according to the first exemplary embodiment, the photoconductor drum 21 may generate vibration by rotating during image forming operation. Parts S3 and S4 (see FIG. 9) of the generated vibration are occasionally transmitted to the frames 15F and 15R.

In the image forming apparatus 1, however, propagation of the parts S3 and S4 of the vibration is reduced or eliminated by the anti-vibration members 62F and 62R.

In the image forming apparatus 1, as illustrated in FIG. 5, the interval maintaining members 214 and 215 and contact portions of the exposure device 23 are in contact with each other.

Also in this case, however, the image forming apparatus 1 is effective when the meshing frequency of the photoconductor drum 21 is set in accordance with the settings but the meshing frequencies of the other devices such as the developing device 24 are not set in accordance with the settings. The image forming apparatus 1 is also effective when the magnitude of the parts S1 and S2 of the vibration to be transmitted to the exposure device 23 via the interval maintaining members 214 and 215 is at an allowable level, for example.

### Fourth Exemplary Embodiment

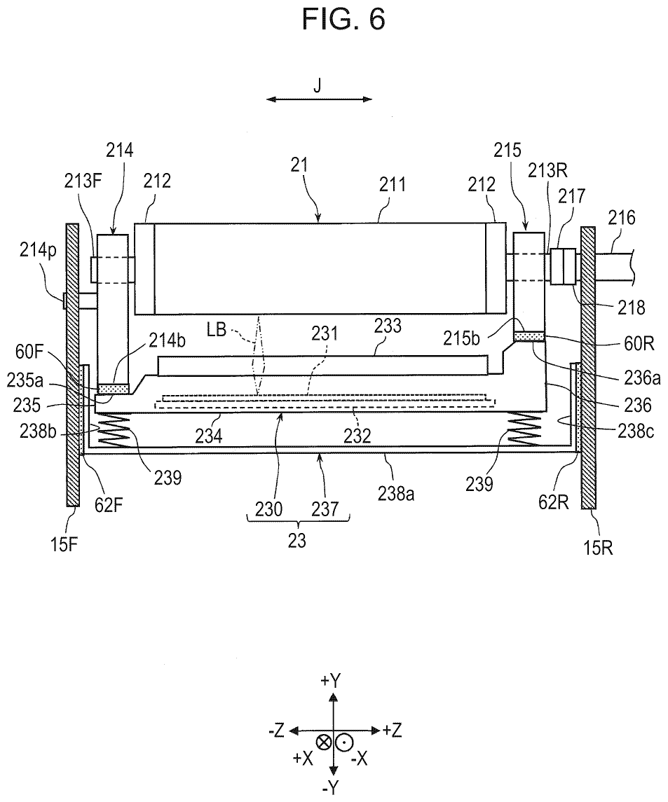

FIG. 6 illustrates an overview of components to suppress propagation of vibration to the exposure device 23 of an image forming apparatus according to a fourth exemplary embodiment.

The image forming apparatus 1 according to the fourth exemplary embodiment has the same configuration as the image forming apparatus 1 according to the first exemplary embodiment except that components to suppress propagation of vibration are partially changed.

In the fourth exemplary embodiment, the components to suppress propagation of vibration according to the third exemplary embodiment are added to the components to suppress propagation of vibration according to the first exemplary embodiment.

That is, in the fourth exemplary embodiment, the anti-vibration members 62F and 62R are interposed between the exposure device 23 and contact portions of the frames 15F and 15R, in addition to interposing the anti-vibration members 60F and 60R between the interval maintaining members 214 and 215 and contact portions of the exposure device 23.

In the image forming apparatus 1 according to the fourth exemplary embodiment, transmission of the parts S1 and S2 (see FIG. 9) of the vibration generated when the photoconductor drum 21 rotates during image forming operation to the exposure device 23 via the interval maintaining members 214 and 215 is reduced or eliminated by the anti-vibration members 60F and 60R.

In the image forming apparatus 1, in addition, transmission of the parts S3 and S4 (scc FIG. 9) of the vibration generated when the photoconductor drum 21 rotates during image forming operation to the exposure device 23 via the frames 15F and 15R is reduced or eliminated by the anti-vibration members 62F and 62R.

### Fifth Exemplary Embodiment

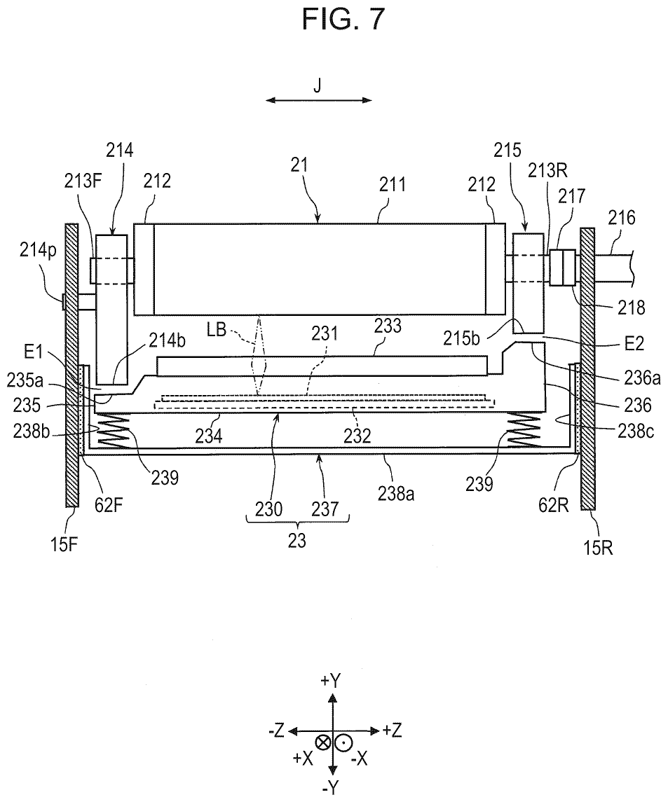

FIG. 7 illustrates an overview of components to suppress propagation of vibration to the exposure device 23 of an image forming apparatus according to a fifth exemplary embodiment.

The image forming apparatus 1 according to the fifth exemplary embodiment has the same configuration as the image forming apparatus 1 according to the second exemplary embodiment except that components to suppress propagation of vibration are partially changed.

In the fifth exemplary embodiment, the components to suppress propagation of vibration according to the third exemplary embodiment are added to the components to suppress propagation of vibration according to the second exemplary embodiment.

That is, in the fifth exemplary embodiment, the anti-vibration members 62F and 62R are interposed between the exposure device 23 and contact portions of the frames 15F and 15R, in addition to spacing the interval maintaining members 214 and 215 and contact portions of the exposure device 23 from each other.

In the image forming apparatus 1 according to the fifth exemplary embodiment, transmission of the parts S1 and S2 (see FIG. 9) of the vibration generated when the photoconductor drum 21 rotates during image forming operation to the exposure device 23 via the interval maintaining members 214 and 215 is blocked by the presence of the gaps E1 and E2 due to the spacing.

In the image forming apparatus 1, in addition, transmission of the parts S3 and S4 (see FIG. 9) of the vibration generated when the photoconductor drum 21 rotates during image forming operation to the exposure device 23 via the frames 15F and 15R is reduced or eliminated by the anti-vibration members 62F and 62R.

### Modifications

The present disclosure is not limited to the configurations exemplified as the above first to fifth exemplary embodiments. That is, the present disclosure may be subjected to a variety of modifications, combinations, etc., without departing from the scope of the disclosure set forth in the claims.

The present disclosure may also include the following modifications, for example.

The photoconductor drum 21 and the exposure device 23 are not limited to the configuration in which the exposure device 23 is disposed at a position substantially directly below the photoconductor drum 21. That is, the photoconductor drum 21 and the exposure device 23 may be configured such that the exposure device 23 is disposed at other positions such as a position substantially directly above the photoconductor drum 21 or a position substantially right beside the photoconductor drum 21.

The photoconductor drum 21, the exposure device 23, etc., may be structured to be removably mountable to a mounting portion of the housing 10 of the image forming apparatus 1.

When such a structure is adopted, a structure in which the photoconductor drum 21 and the exposure device 23 are temporarily away during mounting and unmounting work is also employed.

In this case, the frame 15F is divided into a portion to which the photoconductor drum 21 is to be attached and a portion to which the exposure device 23 is to be attached, and the divided frame portions are configured to be coupled to be mounted.

In the present disclosure, a photoconductor belt in the form of a belt may be applied as the photoconductor in place of the photoconductor drum 21.

The image forming apparatus 1 according to the present disclosure may use a photoconductor and an exposure device that forms a latent image by radiating light from light emitting elements disposed along the axial direction J of the photoconductor.

Therefore, the image forming apparatus 1 is not limited to one that forms a color (multi-color) image, and may be one that forms a monochrome image (such as a black-and-white image).

The image forming unit 2 of the image forming apparatus 1 may be an image forming unit that does not employ the intermediate transfer unit 30.

Further, the imaging portion 20 of the image forming unit 2 is not limited to one composed of the four imaging units 20A, 20B, 20C, and 20D. The number of the imaging units may be a plural number other than four or may be one.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

An image forming apparatus including:
a rotatable photoconductor;
an exposure device that forms a latent image by radiating light from a light emitting element disposed along an axial direction of the photoconductor;
an interval maintaining member that maintains an interval between the photoconductor and the exposure device; and
a support member to which at least the photoconductor and the exposure device are attached, in which an anti-vibration member is interposed between the interval maintaining member and a contact portion of the exposure device.
   (((2)))

An image forming apparatus including:
a rotatable photoconductor;
an exposure device that forms a latent image by radiating light from a light emitting element disposed along an axial direction of the photoconductor;
an interval maintaining member that maintains an interval between the photoconductor and the exposure device; and
a support member to which at least the photoconductor and the exposure device are attached,
in which the interval maintaining member and the exposure device are spaced from each other.
   (((3)))

An image forming apparatus including:
a rotatable photoconductor;
an exposure device that forms a latent image by radiating light from a light emitting element disposed along an axial direction of the photoconductor;
an interval maintaining member that maintains an interval between the photoconductor and the exposure device; and
a support member to which at least the photoconductor and the exposure device are attached,
in which an anti-vibration member is interposed between the exposure device and a contact portion of the support member.
   (((4)))

The image forming apparatus according to (((1))).
in which an anti-vibration member is interposed between the exposure device and a contact portion of the support member.
   (((5)))

The image forming apparatus according to (((2))).
in which an anti-vibration member is interposed between the exposure device and a contact portion of the support member.

What is claimed is:

1. An image forming apparatus comprising:
a rotatable photoconductor;
an exposure device that forms a latent image by radiating light from a light emitting element disposed along an axial direction of the photoconductor;
an interval maintaining member that maintains an interval between the photoconductor and the exposure device; and
a support member to which at least the photoconductor and the exposure device are attached,
wherein an anti-vibration member is interposed between the interval maintaining member and a contact portion of the exposure device.

2. An image forming apparatus comprising:
a rotatable photoconductor;
an exposure device that forms a latent image by radiating light from a light emitting element disposed along an axial direction of the photoconductor;
an interval maintaining member that maintains an interval between the photoconductor and the exposure device; and
a support member to which at least the photoconductor and the exposure device are attached,
wherein the interval maintaining member and the exposure device are spaced from each other.

3. An image forming apparatus comprising:
a rotatable photoconductor;
an exposure device that forms a latent image by radiating light from a light emitting element disposed along an axial direction of the photoconductor;
an interval maintaining member that maintains an interval between the photoconductor and the exposure device; and
a support member to which at least the photoconductor and the exposure device are attached,
wherein an anti-vibration member is interposed between the exposure device and a contact portion of the support member.

4. The image forming apparatus according to claim 1,
wherein an anti-vibration member is interposed between the exposure device and a contact portion of the support member.

5. The image forming apparatus according to claim 2,
wherein an anti-vibration member is interposed between the exposure device and a contact portion of the support member.
